(19) United States
(12) Patent Application Publication
(10) Pub. No.: US 2023/0114768 A1
(43) Pub. Date: Apr. 13, 2023

(54) RELAY APPARATUS, BASE STATION APPARATUS, CONTROL METHOD, AND COMPUTER-READABLE STORAGE MEDIUM FOR STREAMLINING PROCESSING FOR CHANGING CONNECTION DESTINATION OF RELAY APPARATUS

(71) Applicant: KDDI CORPORATION, Tokyo (JP)

(72) Inventors: Hiroki TAKEDA, Tokyo (JP); Yanwei LI, Tokyo (JP)

(21) Appl. No.: 18/080,308

(22) Filed: Dec. 13, 2022

Related U.S. Application Data
(63) Continuation of application No. PCT/JP2021/024126, filed on Jun. 25, 2021.

(30) Foreign Application Priority Data
Jun. 26, 2020 (JP) 2020-110809

(51) Int. Cl. H04W 16/26; H04W 76/27; H04W 76/19

(52) U.S. Cl. CPC H04W 16/26; H04W 76/27; H04W 76/19; H04W 36/08

(57) ABSTRACT

A relay apparatus that relays communication between a base station apparatus and a communication apparatus that is connected to the base station apparatus notifies, in a case where the relay apparatus is connected to another base station apparatus, the other base station apparatus of information regarding the communication apparatus.

### CROSS-REFERENCE TO RELATED APPLICATION(S)

This application is a continuation of International Patent Application No. PCT/JP2021/024126 filed on Jun. 25, 2021, which claims priority to and the benefit of Japanese Patent Application No. 2020-110809 filed Jun. 26, 2020, the entire disclosures of which are incorporated herein by reference.

### BACKGROUND OF THE INVENTION

### Field of the Invention

The present invention relates to processing for changing a connection destination of a relay apparatus that relays communication between a base station apparatus and a terminal apparatus.

### Description of the Related Art

In 3rd Generation Partnership Project (3GPP), a technique for applying, to a backhaul link, a method for a terminal apparatus to access a network, and making the method usable has been considered (see 3GPP, TR38.874, V16.0.0, December, 2018). This technique is called “Integrated Access and Backhaul (IAB)”. A relay apparatus called “IAB node” establishes connection to a 5G base station apparatus (IAB donor) using a wireless link, for example. At this time, the IAB node may be directly connected to the IAB donor by establishing a wireless link, or may be indirectly connection to the IAB donor by establishing a wireless link to another IAB node connected directly or indirectly to the IAB donor. At this time, the IAB node functions as a terminal apparatus connected to the base station apparatus, and thereby establishes wireless connection to the above-mentioned other apparatus (upstream apparatus) on the IAB donor side. In addition, after connection to the IAB donor has been established, the IAB node can establish connection to another IAB node or a terminal apparatus that is to be connected to the IAB donor. In this case, the IAB node operates in a similar manner to the base station apparatus, and establishes wireless connection to a terminal apparatus or another IAB node that operates as a terminal apparatus (downstream apparatus). In this manner, the IAB node has a terminal function (MT, Mobile Termination) and a function (DU, Distributed Unit) for performing an operation similar to that of a base station apparatus, and can relay communication between an upstream apparatus and a downstream apparatus using these functions.

In 3GPP release 17, starting consideration on a topology change technique that is accompanied by a switch of an IAB donor, namely a connection partner of an IAB node has been proposed (3GPP, RP-193251, December, 2019). With this technique, when an IAB node installed in a mobile object such as a train or a bus moves, it is possible to maintain communication of the IAB donor itself and communication of another apparatus connected to the IAB donor.

### SUMMARY OF THE INVENTION

The present invention provides a technique for streamlining processing that is performed when an IAB node switches a connection destination thereof, namely an IAB donor.

A relay apparatus according to one mode of the present invention is a relay apparatus that relays communication between a base station apparatus and a communication apparatus that is connected to the base station apparatus, and includes one or more processors; and one or more memories that store a computer-readable instruction for causing, when executed by the one or more processors, the relay apparatus to: notify, in a case where the relay apparatus fails in a handover from the base station apparatus, and is reconnected to another base station apparatus, the other base station apparatus of information regarding the communication apparatus.

A base station apparatus according to another mode of the present invention includes: one or more processors; and one or more memories that store a computer-readable instruction for causing, when executed by the one or more processors, the base station apparatus to: receive, in a case where a relay apparatus that relays communication between another base station apparatus and a communication apparatus that is connected to the other base station apparatus fails in a handover, and is reconnected to the base station apparatus, first information regarding the communication apparatus from the relay apparatus, obtain second information that includes a connection parameter that the communication apparatus used when the communication apparatus was connected to the other base station apparatus via the relay apparatus, from the other base station apparatus based on the first information, and establish Radio Resource Control (RRC) connection to the communication apparatus via the relay apparatus based on the second information.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an exemplary configuration of a wireless communication system.

FIG. 2 is a diagram showing an exemplary hardware configuration of an IAB donor and an IAB node.

FIG. 3 is a diagram showing an exemplary functional configuration of the IAB node.

FIG. 4 is a diagram showing an exemplary functional configuration of the IAB donor.

FIG. 5 is a diagram showing an example of flow of processing that is executed by a wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

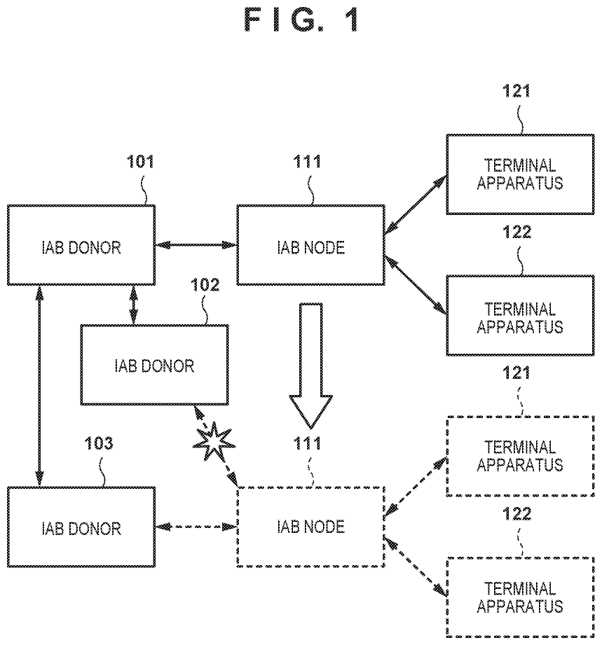

FIG. 1 shows an exemplary configuration of a wireless communication system according to the present embodiment. The wireless communication system according to the present embodiment is a relay transmission system that is based on Integrated Access and Backhaul (IAB) stipulated in 3GPP, and is constituted by an IAB donor 101 and IAB node 111. The IAB node 111 is a relay apparatus that relays communication between the IAB donor 101 and a terminal apparatus 121 or a terminal apparatus 122. That is to say, the terminal apparatus 121 or the terminal apparatus 122 is connected to the IAB donor 101 via the IAB node 111. Note that it may be interpreted that the IAB donor functions as a base station apparatus, and the IAB node functions as a relay apparatus. In the present embodiment, due to movement of the IAB node 111, deterioration in the quality of communication with the IAB donor 101 connected to the IAB node 111, or the like, processing for switching connection to the IAB donor 101 to connection to another IAB donor 102 is executed (a handover is performed).

The terminal apparatus 121 and the terminal apparatus 122 are connected to the IAB donor 101 via the IAB node 111. Therefore, in a case where the IAB node 111 performs a handover to the IAB donor 102, the terminal apparatus 121 and the terminal apparatus 122 also require processing for changing a connection destination. Thus, the IAB donor 101 separately generates a control signal for a handover of the IAB node 111 and control signals for a handover of the communication apparatuses (terminal apparatus or other IAB node) connected downstream of the IAB node 111, and transmits the generated control signals to the IAB donor 102 that is a handover destination. Note that the control signal for a handover of each of the terminal apparatuses (the IAB node 111, the terminal apparatus 121, and the terminal apparatus 122) may include identification information (ID) and the name of the terminal apparatus and information regarding a connection parameter that has been used by the terminal apparatus. Note that this control signal corresponds to a HANDOVER REQUEST message that is transmitted from a base station apparatus that is a handover source to a base station apparatus that is a handover destination, in a conventional method. Note that, having transmitted this control signal, the IAB donor 101 may erase information regarding the IAB node 111, and the communication apparatuses (terminal apparatus or other IAB node) connected downstream of the IAB node 111.

Note that the above-mentioned identification information (ID) can be a ReestabUE-Identity derived (calculated, for example) from Cell Radio Network Temporary Identifier (C-RNTI), or C-RNTI and physical cell ID (physCellId), which is an identifier that is allocated to each of the terminal apparatuses and IAB nodes by the base station apparatus. In addition, if a communication apparatus connected downstream of the IAB node 111 is an IAB node, Global NG-RAN Node ID or IP address allocated to the IAB node (as a 5G wireless access network node) may be used as identification information (ID).

On receiving the control signals for a handover of the IAB node 111 and the terminal apparatuses 121 and 122, the IAB donor 102 that is a handover destination transmits response signals to the control signals, to the IAB donor 101. A response signal here may include, for each of the IAB nodes and terminal apparatuses, information regarding a connection parameter that is to be used after a handover and that is determined, for example, based on a connection parameter that has been used. Note that this response signal corresponds to a Handover Request Acknowledge message that is transmitted from a base station apparatus that is a handover destination to a base station apparatus that is a handover source.

On receiving a response signal, the IAB donor 101 transmits, to the IAB node 111, the control signal for a handover of the IAB node 111 and the control signals for a handover of the communication apparatuses connected downstream of the IAB node 111. Note that, here, a control signal for a handover corresponds to a conventional RRC Reconfiguration message, for example. Here, the control signal for the IAB node 111 may include information indicating that processing (for example, random access processing) for establishing synchronization with the connection destination to which a switch is to be made (IAB donor 102) is necessary.

On the other hand, there is no change in the partner apparatus (for example, the IAB node 111, for the terminal apparatus 121 and the terminal apparatus 122) to which the communication apparatuses connected downstream of the IAB node 111 are directly connected, and thus control signals for these apparatuses may include information indicating that synchronization establishment processing is not necessary. Thus, upon receiving the control signal, each of the communication apparatuses connected downstream of the IAB node 111 transmits a response message (RRC Reconfiguration Complete message) to the IAB node 111 without executing random access processing or the like, and may determine that a handover has been successfully performed, in accordance with receiving a positive response to the response message. At this time, the control signal received via the IAB node 111 includes information regarding a connection parameter for connection to the IAB donor 102, and thus a state is achieved in which each apparatus may determine that connection to the IAB donor 102 has been established.

However, the communication apparatuses connected downstream of the IAB node 111 can maintain connection to the IAB node 111 as is, but there may be cases where the IAB node 111 cannot establish connection to the IAB donor 102. In other words, there may be cases where the IAB node 111 fails in a handover (for example, random access). At this time, the IAB node 111 can establish connection by executing reconnection processing with another IAB donor 103 (or another IAB node that relays communication with the IAB donor). In this case, the IAB donor 103 that is a reconnection destination of the IAB node 111 does not recognize the communication apparatuses connected downstream of the IAB node 111, and the communication apparatuses cannot perform communication from that point on. Thus, the communication apparatuses need to be reconnected to a base station apparatus in order to resume communication. The communication apparatuses execute processing such as cell search again, which requires a long time before resuming communication.

In light of such circumstances, when the IAB node 111 according to the present embodiment fails in a handover, executes reconnection processing with the other IAB donor 103, and successfully establishes connection, the IAB node 111 notifies the IAB donor 103 of information regarding the communication apparatuses connected downstream of the IAB node 111 before handover processing.

Note that the above-mentioned information regarding the communication apparatus may be transmitted at a predetermined timing after the IAB node 111 establishes connection to the IAB donor 103. The IAB node 111 may notify the IAB donor 103 of the information regarding the communication apparatuses connected downstream of the IAB node 111, for example, in accordance establishment of Radio Resource Control (RRC) connection to the IAB donor 103. The IAB node 111 receives an RRC Reconfiguration message from the IAB donor 103, and transmits an RRC Reconfiguration Complete message in response to the received message, to the IAB donor 103, thereby establishing RRC connection to the IAB donor 103, for example. At this time, the IAB node 111 may perform notification of the information regarding the communication apparatuses connected downstream, using the RRC Reconfiguration Complete message. In addition, after transmitting the RRC Reconfiguration Complete message, the IAB node 111 may perform notification of the information regarding the communication apparatuses connected downstream, using another message. Furthermore, the IAB node 111 needs to execute setting for functioning as a relay apparatus that relays communication between the IAB donor 103 and the terminal apparatuses. The IAB node 111 establishes an F1 interface to the IAB donor 103 through this setting, for example. After the F1 interface is established, the IAB node 111 may then perform notification of the information regarding the communication apparatuses connected downstream, using a predetermined F1 message, for example. In addition, the IAB node 111 may perform notification of the information regarding the communication apparatuses connected downstream, for example, in an F1 Setup Request message for establishing an F1 interface.

In accordance with the IAB node 111 having requested for establishment of reconnection, the IAB donor 103 transmits a request message (Retrieve UE Context Request) to the IAB donor 101 that is the most recent connection destination, receives a response message (Retrieve UE Context Response) to the transmitted message, and can thereby obtain a UE Context of the IAB node 111. Similarly, in accordance with obtaining the information regarding the communication apparatuses connected downstream of the IAB node 111, from the IAB node 111, the IAB donor 103 transmits a request message for the communication apparatuses to the IAB donor 101. The IAB donor 103 then obtains UE Contexts of the communication apparatuses from the IAB donor 101. In this manner, the IAB node 111 notifies the IAB donor 103 of information that enables the IAB donor 103 to specify apparatuses that are target for obtaining UE Contexts. The IAB node 111 provides identification information of the communication apparatuses connected downstream of the IAB node 111, to the IAB donor 103, for example. Note that any information that enables communication apparatuses to be specified may be provided to the IAB donor 103. Note that, in a case where the IAB node 111 holds the UE Contexts of the communication apparatuses connected downstream of the IAB node 111, the IAB node 111 may transmit the information to the IAB donor 103.

When obtaining the UE Contexts of the communication apparatuses connected downstream of the IAB node 111, the IAB donor 103 notifies the communication apparatuses that the IAB donor 103 has become a reconnection destination, for example, using an RRC Reconfiguration message. This RRC Reconfiguration message is transmitted to the communication apparatuses via the IAB node 111, for example. The communication apparatuses then transmit an RRC Reconfiguration Complete message to the IAB donor 103 (for example, via the IAB node 111) in response to this RRC Reconfiguration message, thereby establishing RRC connection to the IAB donor 103. Here, if a communication apparatus is an IAB node, setting for functioning as a relay apparatus that relays communication between the IAB donor 103 and a terminal apparatus is executed. This setting is similar to setting that is executed by the IAB node 111.

Note that the UE Context of each of the IAB node 111 and the communication apparatuses may include information regarding a connection parameter that the apparatus used when the apparatus was connected to the IAB donor 101. The IAB donor 103 then determines a connection parameter of the apparatus based on the connection parameter included in the UE Context and connection parameters that can be used for communication of the IAB donor 103, for example, and provides the determined connection parameter to the apparatus using an RRC Reconfiguration message. Accordingly, the communication apparatus can be connected to an IAB donor to which the upstream IAB node 111 has established connection, using an appropriate connection parameter corresponding to the IAB donor.

Note that the IAB node 111 may notify the IAB donor 103 of only information regarding a communication apparatus directly connected to the IAB node 111, for example. That is to say, a configuration may be adopted in which, if another IAB node is connected downstream of the IAB node 111, the IAB node 111 notifies the IAB donor 103 of information regarding the IAB node, and does not notify the IAB donor 103 of information regarding a communication apparatus connected further downstream of the IAB node. In this case, after connection (RRC connection) to the IAB donor 103 has been established as will be described below, the IAB node connected downstream of the IAB node 111 may transmit information regarding the other communication apparatus connected downstream of the IAB node, to the IAB donor 103. As a result of repeating this processing, the IAB donor 103 that is a reconnection destination of the IAB node 111 is notified of the information regarding the communication apparatuses connected downstream of the IAB node 111. In this processing, it suffices for the IAB node 111 to be aware of only the information regarding the communication apparatuses connected thereto, and, in addition, it is possible to reduce the amount of information for notification.

Moreover, the IAB node 111 may also notify the IAB donor 103 of information regarding a communication apparatus indirectly connected to the IAB node 111, for example. Specifically, if another IAB node is connected downstream the IAB node 111, the IAB node 111 may notify the IAB donor 103 of not only information regarding the IAB node, but also information regarding another communication apparatus connected further downstream of the IAB node. In this processing, by performing notification of information once, the IAB donor 103 that is a reconnection destination of the IAB node 111 is notified of information regarding the communication apparatuses connected downstream of the IAB node 111. In this processing, a communication apparatus for which the connection destination that is directly connected to the communication apparatus has not changed does not need to perform notification to the IAB donor 103, and the IAB donor 103 is notified of information regarding the downstream communication apparatuses within a certain period of time, irrespective of the hop count of relay.

In the above-described manner, even in a case where an IAB node fails in connection to a base station apparatus (IAB donor) that is a handover destination candidate, and is connected to another base station apparatus, information regarding communication apparatuses connected downstream of the IAB node is provided to the other base station apparatus, and thus the communication apparatuses do not need to perform connection processing from cell search again. As a result, it is possible for the communication apparatuses to shorten a period during which communication cannot be executed due to a switch of a connection destination of the IAB node 111.

Note that FIG. 1 illustrates a case in which the IAB node 111 is directly connected to the IAB donor 101 and the IAB donor 103, but may also be connected to the IAB donor via another IAB node. In addition, the terminal apparatus 121 or the terminal apparatus 122 may be another IAB node. In addition, FIG. 1 shows only a small number of IAB donors, IAB nodes, and terminal apparatuses, but there may be a larger number of IAB donors, IAB nodes, and terminal apparatuses without loss of generality.

### Apparatus Configuration

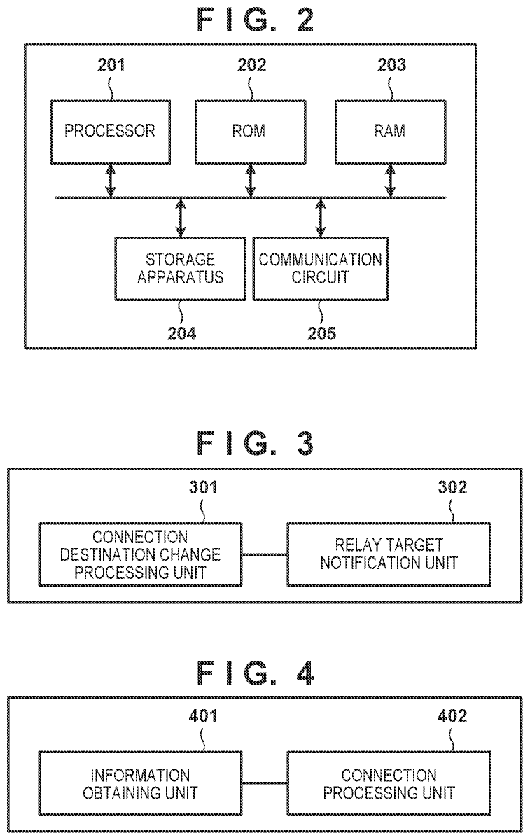

Next, the configuration of an IAB donor and an IAB node that execute processing such as that described above will be described. FIG. 2 shows an exemplary hardware configuration of an IAB donor or an IAB node. The IAB donor and the IAB node each include a processor 201, a ROM 202, a RAM 203, a storage apparatus 204, and a communication circuit 205, as an example. In the IAB donor and the IAB node, for example, a computer-readable program that realizes the above-described functions of the IAB donor and the IAB node, and is recorded in one of the ROM 202, the RAM 203, and the storage apparatus 204 is executed by the processor 201. Note that, the processor 201 may be replaced with one or more processors such as an application-specific integrated circuit (ASIC), Field Programmable Gate Arrays (FPGA), and a digital signal processor (DSP).

The processor 201 of the IAB donor or the IAB node controls the communication circuit 205 so as to perform communication with a partner apparatus (an IAB donor, an IAB node, a terminal apparatus, or the like), for example. Note that FIG. 2 shows a schematic diagram in which the IAB donor or the IAB node includes one communication circuit 205, but there is no limitation thereto. The IAB donor may include a communication circuit for communicating with an IAB node and a terminal apparatus, and a communication circuit for communicating with another IAB donor, for example. In addition, the IAB node may include a communication circuit for communicating with an IAB donor and a communication circuit for communicating with another IAB node and a terminal apparatus, for example.

FIG. 3 shows an exemplary functional configuration of an IAB node. The IAB node is constituted by a connection destination change processing unit 301 and a relay target notification unit 302, for example. Note that the IAB node is configured to be capable of performing ordinary functions of an IAB node in addition to these as a matter of course. In addition, a portion or the entirety of the functional configuration may be realized by the processor 201 executing a program stored in the ROM 202 or the storage device 204, for examples. Moreover, dedicated hardware that realizes this functional configuration may be prepared. In addition, for example, the functional configuration in FIG. 3 may also be realized by a processor included in the communication circuit 205 executing a dedicated program. In addition, a portion of the functions in FIG. 3 may be omitted, or a function in FIG. 3 may be replaced with another functions that has similar capability.

Upon receiving a handover instruction from an IAB donor connected to the IAB node, for example, the connection destination change processing unit 301 executes handover processing for changing a connection destination, namely an IAB donor. In accordance with receiving an RRC Reconfiguration message that includes a handover instruction from the IAB donor connected to the IAB node, for example, the connection destination change processing unit 301 transmits a random access preamble to an IAB donor that is a handover destination (or another IAB node connected to the IAB donor). The connection destination change processing unit 301 then receives a random access response, thereby establishing synchronization with the IAB donor that is a handover destination, and then establishing RRC connection. In addition, for example, if a random access response to the random access preamble could not be received, the connection destination change processing unit 301 may determine that it is not possible to establish connection to the IAB donor that is a handover destination, and execute processing for reconnection to another IAB donor. The connection destination change processing unit 301 transmits an RRC Reestablishment Request message to an IAB donor selected as a connection destination, for example. The connection destination change processing unit 301 then receives an RRC Reestablishment message from the IAB donor, and, in response, returns an RRC Reestablishment Complete message to the IAB donor. Accordingly, the connection destination change processing unit 301 can establish RRC connection to the IAB donor. The connection destination change processing unit 301 then executes setting such as establishment of an F1 interface in order to function as a relay apparatus that relays communication between the IAB donor that is a connection destination and terminal apparatuses.

If, for example, the connection destination change processing unit 301 fails in a handover to an IAB donor specified as a handover destination, and is connected to another IAB donor, the relay target notification unit 302 notifies the IAB donor that is a connection destination of information that enables the communication apparatuses connected downstream of the IAB node to be specified (for example, identification information) in a state immediately before the connection destination, namely the IAB donor is changed. The relay target notification unit 302 may add, to an RRC Reestablishment Complete message, the information that enables the communication apparatuses to be specified, to notify the IAB donor that is a connection destination of the information, for example. In addition, after transmitting the RRC Reestablishment Complete message, the relay target notification unit 302 may notify the IAB donor of the information that enables the communication apparatus to be specified, using another message, for example. Moreover, for example, the relay target notification unit 302 may notify the IAB donor of the information that enables the communication apparatuses to be specified, using an F1 message after an F1 interface has been established. Moreover, the relay target notification unit 302 may notify the IAB donor of only the information regarding a downstream communication apparatus directly connected to the IAB node, or may also notify the IAB donor of information regarding a communication apparatus indirectly connected to IAB node via another IAB node.

FIG. 4 shows an exemplary functional configuration of an IAB donor. The IAB donor is constituted by an information obtaining unit 401 and a connection processing unit 402, for example. Note that the IAB donor is configured to be capable of performing ordinary functions of an IAB donor in addition to these as a matter of course. In addition, a portion or the entirety of the functional configuration may be realized by the processor 201 executing a program stored in the ROM 202 or the storage apparatus 204, for example. In addition, dedicated hardware that realizes this functional configuration may be prepared. The functional configuration in FIG. 4 may also be realized by a processor included in the communication circuit 205 executing a dedicated program, for example. Some of the functions in FIG. 4 may be omitted, or a function in FIG. 4 may be replaced with another function that has similar capability.

In accordance with receiving an RRC Reestablishment Request from an IAB node, for example, the information obtaining unit 401 transmits a request message to an IAB donor to which the IAB node was connected most recently, in order to obtain the UE Context of the IAB node. The information obtaining unit 401 then obtains the UE Context of the IAB node from the IAB donor. The connection processing unit 402 then establishes connection to the IAB node based on the UE Context. Here, the UE Context may include a connection parameter that the IAB node used before a switch of connection. In this case, the connection processing unit 402 determines a connection parameter that the IAB node is to use after a switch of connection, based on the UE Context and connection parameters that can be used by the IAB donor, and transmits an RRC Reestablishment message that includes the determined connection parameter to the IAB node. Accordingly, the IAB node can perform communication using an appropriate connection parameter after the connection destination is switched.

In addition, the information obtaining unit 401 obtains, from the IAB node connected through reconnection processing, information that enables the communication apparatuses connected downstream of the IAB node to be specified, before the IAB node changes the connection destination. The information obtaining unit 401 then requests an IAB donor to which the IAB node was connected most recently, for the UE Contexts of the communication apparatuses, based on the information that enables the communication apparatuses to be specified. When the information obtaining unit 401 obtains the UE Context information of the communication apparatuses, the connection processing unit 402 establishes connection to the communication apparatuses based on the UE Contexts. Here, as described above, a UE Context may include information regarding a connection parameter that the communication apparatuses used before the IAB node switched the connection destination. In this case, the connection processing unit 402 determines a connection parameter that the IAB node is to use after a switch of connection, based on the UE Context and connection parameters that can be used by the IAB donor, and transmits an RRC Reconfiguration message that includes the determined connection parameter, to the communication apparatuses. Note that this message may be transmitted to the communication apparatuses via the IAB node.

### Flow of Processing

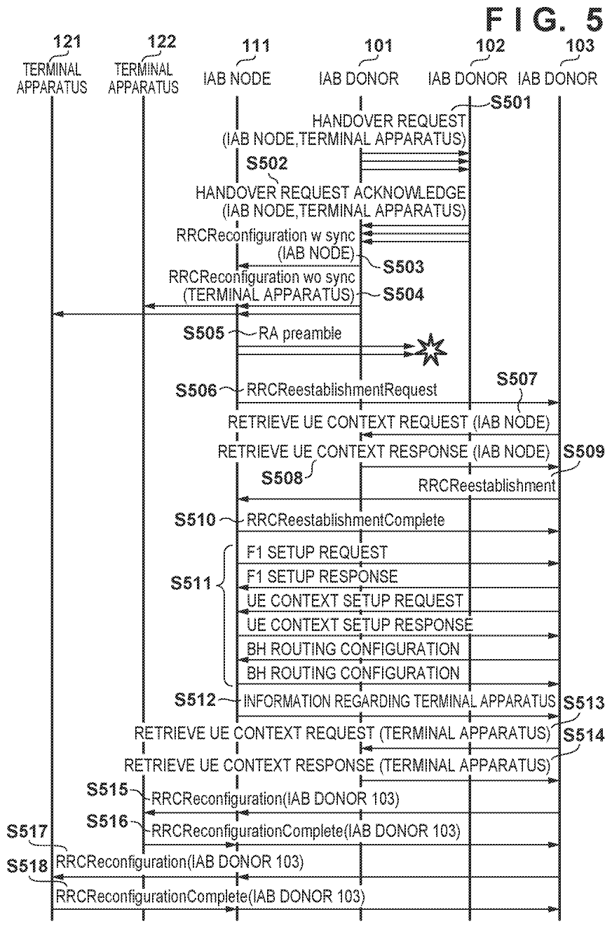

Next, an example of flow of processing that is executed by the wireless communication system will be described with reference to FIG. 5. Note that the following describes an example of a case where, after serving as a relay apparatus and completing setting processing such as establishment of an F1 interface to the IAB donor 103 that is a reconnection destination, the IAB node 111 notifies the IAB donor 103 of information regarding downstream communication apparatuses. Note that this is merely exemplary, and, as described above, the IAB node 111 may perform notification of the information regarding the communication apparatuses using an RRC Reestablishment Complete message at the time of reconnection, or may perform notification of information regarding the communication apparatuses after transmitting the RRC Reestablishment Complete message, using another message. In addition, for example, after establishing an F1 interface, and before serving as a relay apparatus and completing setting (such as setting of a relay path), the IAB node 111 may perform notification of the information regarding the communication apparatuses using an F1 message.

In this processing, first, the IAB donor 101 connected to the IAB node 111 determines that a handover of the IAB node 111 is to be performed, in accordance with deterioration in first wireless quality of a signal received by the IAB node 111 from the IAB donor 101, second wireless quality of a signal received by the IAB node 111 from the IAB donor 102 exceeding the first wireless quality by more than a predetermined level, or the like. The IAB donor 101 then specifies the communication apparatuses connected downstream of the IAB node 111, generates Handover Request messages for the apparatuses, and a Handover Request message for the IAB node 111, and transmits the messages to the IAB donor 102 that is a handover destination (step S501). The IAB donor 102 obtains information such as connection parameters that are being used by the apparatuses, from the Handover Request messages for the respective apparatuses. The IAB donor 102 then determines connection parameters to be used by the apparatuses after a handover, and the like, generates Handover Request Acknowledge messages for the respective apparatuses, the messages including the information, and transmits the messages to the IAB donor 101 that is a handover source (step S502).

Upon receiving the Handover Request Acknowledge messages, the IAB donor 101 generates RRC Reconfiguration messages for the IAB node 111 and the communication apparatuses connected downstream of the IAB node 111, based on the received messages, and transmits the messages to the IAB node 111 (steps S503 and S504). At this time, the RRC Reconfiguration message for the IAB node 111 may indicate that synchronization establishment processing such as random access processing is to be executed. On the other hand, the RRC Reconfiguration messages for the communication apparatuses connected downstream of the IAB node 111 may indicate that synchronization establishment processing such as random access processing is not to be executed. Note that, in FIG. 5, “w sync” indicates that synchronization establishment processing is necessary, and “wo sync” indicates that synchronization establishment processing is not necessary. Here, in FIG. 5, the IAB node 111 transfers the RRC Reconfiguration message for the downstream communication apparatuses, to the downstream communication apparatus. Accordingly, the downstream communication apparatuses complete handover processing.

Next, the IAB node 111 first attempts connection to the IAB donor 102 that is a handover destination. Specifically, the IAB node 111 transmits a random access (RA) preamble to the IAB donor 102, based on the RRC Reconfiguration message to the IAB node 111, in order to establish synchronization with the IAB donor 102 (step S505). Here, assume that, in this processing example, the IAB donor 102 cannot detect an RA preamble, and does not transmit an RA response. If the IAB node 111 cannot receive an RA response, and determines that a handover has failed, the IAB node 111 transmits an RRC Reestablishment Request message for reconnection with another IAB donor 103, to the IAB donor 103 (step S506). Upon receiving the RRC Reestablishment Request message from the IAB node 111, the IAB donor 103 transmits a Retrieve UE Context Request message for making a request to obtain the UE Context of the IAB node 111, to a base station apparatus (the IAB donor 101) to which the IAB node 111 was connected most recently (step S507). The IAB donor 103 then receives a Retrieve UE Context Response message from the IAB donor 101 (step S508), and obtains the UE Context of the IAB node 111 included in the message. The IAB donor 103 specifies a connection parameter that the IAB node 111 used when the IAB node 111 was connected to the IAB donor 101, using the obtained UE Context, and determines a connection parameter that enables communication that is similar to communication performed using the specified connection parameter, based on connection parameters that can be used by the IAB donor 103, for example. The IAB donor 103 then transmits an RRC Reestablishment message that includes the determined connection parameter and the like, to the IAB node 111 (step S509).

The IAB node 111 then transmits an RRC Reestablishment Complete message to the IAB donor 103 that is a reconnection destination (step S510), and establishes RRC connection to the IAB donor 103. The IAB node 111 then executes setting for operating as a relay apparatus with the IAB donor 103 (step S511). The IAB node 111 transmits a request (F1 Setup Request) message for establishing an F1 interface, to the IAB donor 103, and the IAB donor 103 transmits a response (F1 Setup Response) message to the request message, to the IAB node 111, for example. An UE Context Setup Request and a UE Context Setup Response are then transmitted/received, and routing setting (setting of relay path) of backhaul (BH) is executed. When completing setting for operating as a relay apparatus, the IAB node 111 transmits information regarding the communication apparatuses (the terminal apparatus 121 and the terminal apparatus 122) connected downstream of the IAB node 111 to the IAB donor 103 (step S512). The IAB node 111 may transmit this information to the IAB donor 103 using a newly defined F1 message, for example.

When information regarding the communication apparatuses connected downstream of the IAB node 111 (the terminal apparatus 121 and the terminal apparatus 122) is obtained, the IAB donor 103 requests the IAB donor 101 to which the IAB node 111 was connected most recently, for the UE Contexts of the communication apparatus, and obtains the UE Contexts (steps S513 and S514). The IAB donor 103 then transmits an RRC Reconfiguration message to the communication apparatuses, based on the obtained UE Contexts (the terminal apparatus 121 and the terminal apparatus 122) (steps S515 and S517). Note that this RRC Reconfiguration message may indicate that the connection destination, namely the base station apparatus has been changed to the IAB donor 103. In addition, this RRC Reconfiguration message may include a connection parameter that is to be used by the communication apparatus, and that is selected from connection parameters that can be used by the IAB donor 103, based on each of the UE Contexts. Note that the RRC Reconfiguration message includes information regarding the connection parameters, and does not need to include information indicating the IAB donor 103. The communication apparatuses change settings such as the connection parameters based on this message, return an RRC Reconfiguration Complete message to the IAB donor 103 (steps S516 and S518), and end the processing.

Note that, if the terminal apparatus 121 or the terminal apparatus 122 is an IAB node, processing such as processing of steps S511 is executed between the IAB node and the IAB donor 103 in order for the IAB node to operate as a relay apparatus. At this time, for example, if notification of information regarding communication apparatuses connected downstream of the IAB node is not performed in steps S512, the IAB donor 103 is notified of the information regarding the communication apparatuses from the IAB node. That is to say, if another IAB node is connected downstream of the IAB node 111, after RRC connection is established between the IAB node and the IAB donor 103, the processing in step S511 is executed, and, as necessary, the IAB donor 103 is notified of information regarding communication apparatuses connected further on the downstream side.

With such a procedure, the communication apparatuses (the terminal apparatus 121 and the terminal apparatus 122) connected downstream of the IAB node 111 do not need execute connection resetting processing from processing such as cell search, after reconnection processing of the IAB node 111. Thus, it is possible to shorten a period during which the communication apparatuses cannot execute communication due to a switch of the connection destination of the IAB node 111.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A relay apparatus that relays communication between a base station apparatus and a communication apparatus that is connected to the base station apparatus, comprising:
one or more processors; and
one or more memories that store a computer-readable instruction for causing, when executed by the one or more processors, the relay apparatus to:
notify, in a case where the relay apparatus is connected to another base station apparatus, the other base station apparatus of information regarding the communication apparatus.

2. The relay apparatus according to claim 1, wherein
the relay apparatus adds the information regarding the communication apparatus to an RRC Reestablishment Complete message that is to be transmitted to the other base station apparatus at the time of reconnection to the other base station apparatus.

3. The relay apparatus according to claim 1, wherein
the relay apparatus transmits the information regarding the communication apparatus to the other base station apparatus after reconnection to the other base station apparatus is complete.

4. The relay apparatus according to claim 3, wherein
the relay apparatus transmits the information regarding the communication apparatus to the other base station apparatus after setting for a relay path for relaying communication with the other base station apparatus is complete.

5. The relay apparatus according to claim 3, wherein
the relay apparatus transmits an F1 message that includes the information regarding the communication apparatus, to the other base station apparatus, after setting for an F1 interface to the other base station apparatus is complete.

6. The relay apparatus according to claim 1, wherein
the relay apparatus notifies the other base station apparatus of the information regarding the communication apparatus in a case where the relay apparatus is connected to the other base station apparatus on the occasion of a failure in a handover from the base station apparatus.

7. A base station apparatus, comprising:
one or more processors; and
one or more memories that store a computer-readable instruction for causing, when executed by the one or more processors, the base station apparatus to:
receive, in a case where a relay apparatus that relays communication between another base station apparatus and a communication apparatus that is connected to the other base station apparatus is connected to the base station apparatus, first information regarding the communication apparatus from the relay apparatus;
obtain second information that includes a connection parameter that the communication apparatus used when the communication apparatus was connected to the other base station apparatus via the relay apparatus, from the other base station apparatus based on the first information; and
establish Radio Resource Control (RRC) connection to the communication apparatus via the relay apparatus based on the second information.

8. The base station apparatus according to claim 7, wherein
the base station apparatus obtains information regarding the communication apparatus included in an RRC Reestablishment Complete message transmitted from the relay apparatus at the time of reconnection between the relay apparatus and the base station apparatus.

9. The base station apparatus according to claim 7, wherein
the base station apparatus receives information regarding the communication apparatus from the relay apparatus after reconnection between the relay apparatus and the base station apparatus is complete.

10. The base station apparatus according to claim 9, wherein
the base station apparatus receives the information regarding the communication apparatus from the relay apparatus, after the relay apparatus completes setting for a relay path for relaying communication with the base station apparatus.

11. The base station apparatus according to claim 9, wherein
after setting for an F1 interface to the relay apparatus is complete, the base station apparatus receives the information regarding the communication apparatus included in an F1 message from the relay apparatus.

12. The base station apparatus according to claim 7, wherein
in a case where the relay apparatus is connected to the base station apparatus on the occasion of a failure in a handover from the other base station apparatus, the base station apparatus receives the first information regarding the communication apparatus from the relay apparatus.

13. The base station apparatus according to claim 7, wherein
the second information is a UE Context.

14. The base station apparatus according to claim 7, wherein
the base station apparatus transmits an RRC Reconfiguration message that includes information indicating the base station apparatus, to the communication apparatus.

15. The base station apparatus according to claim 7, wherein
the base station apparatus determines a connection parameter that is to be used by the communication apparatus, based on the second information, and transmits an RRC Reconfiguration message that includes the connection parameter, to the communication apparatus.

16. A control method that is executed by a relay apparatus that relays communication between a base station apparatus and a communication apparatus that is connected to the base station apparatus, the method comprising:
notifying, in a case where the relay apparatus is connected to another base station apparatus, the other base station apparatus of information regarding the communication apparatus.

17. A control method that is executed by a base station apparatus, comprising:
receiving, in a case where a relay apparatus that relays communication between another base station apparatus and a communication apparatus that is connected to the other base station apparatus is connected to the base station apparatus, first information regarding the communication apparatus from the relay apparatus;
obtaining second information that includes a connection parameter that the communication apparatus used when the communication apparatus was connected to the other base station apparatus via the relay apparatus, from the other base station apparatus based on the first information; and
establishing Radio Resource Control (RRC) connection to the communication apparatus via the relay apparatus based on the second information.

18. A non-transitory computer-readable storage medium that stores a program for causing a computer included in a relay apparatus, which relays communication between a base station apparatus and a communication apparatus that is connected to the base station apparatus, to:
notify, in a case where the relay apparatus is connected to another base station apparatus, the other base station apparatus of information regarding the communication apparatus.

19. A non-transitory computer-readable storage medium that stores a program for causing a computer included in a base station apparatus to:
receive, in a case where a relay apparatus that relays communication between another base station apparatus and a communication apparatus that is connected to the other base station apparatus is connected to the base station apparatus, first information regarding the communication apparatus from the relay apparatus;
obtain second information that includes a connection parameter that the communication apparatus used when the communication apparatus was connected to the other base station apparatus via the relay apparatus, from the other base station apparatus based on the first information; and
establish Radio Resource Control (RRC) connection to the communication apparatus via the relay apparatus based on the second information.
